(19) United States
(12) Patent Application Publication
(10) Pub. No.: US 2006/0130479 A1
(43) Pub. Date: Jun. 22, 2006

(54) Turbocharger with blow-by gas injection port

(76) Inventors: Christopher E. Holm, Madison, WI (US); Brian W. Schwandt, Fort Atkinson, WI (US)

Correspondence Address: BAKER & DANIELS LLP, 300 NORTH MERIDIAN STREET, SUITE 2700, INDIANAPOLIS, IN, 46204, US

(21) Appl. No.: 11/018,738

(22) Filed: Dec. 21, 2004

(51) Int. Cl. F02B 33/44; F02D 23/00

(52) U.S. Cl. 60/602; 60/605.1

(57) ABSTRACT

A turbocharger including a compressor having a housing that defines an air intake and a chamber, and a compressor wheel disposed between the air intake and the chamber, the compressor wheel being configured to force gas from the air intake into the chamber. The turbocharger further includes a port having an inlet in fluid communication with a source of gas and an outlet configured to deliver the gas directly into the chamber.

### FIELD OF THE INVENTION

The present invention generally relates to turbochargers, and more particularly to a turbocharger with a blow-by gas injection port.

### BACKGROUND OF THE INVENTION

In an internal combustion engine, combustion gases are blown out from an engine combustion chamber into the crankcase of the engine through a gap or clearance between a piston and the cylinder wall. This gas is commonly referred to as blow-by gas. It includes a pressurized mixture of air, exhaust gases, and atomized oil. At small and large throttle openings, blow-by gas in the crankcase must be vented to avoid the buildup of excessive pressure in the crankcase. Some engines vent the blow-by gas directly (or through a discharge tube) to the atmosphere. This configuration is referred to as “open crankcase ventilation.” Closed crankcase ventilation (“CCV”) configurations re-circulate the blow-by gas back into the air intake of the engine.

One method of venting the blow-by gas is disclosed in U.S. Pat. No. 6,123,061 (the '061 Patent) to Cummins Engine Company, Inc., the disclosure of which is expressly incorporated by reference herein. The '061 Patent discloses a turbocharged internal combustion engine. Turbochargers provide high pressure air to the air intake of internal combustion engines. Turbochargers have been shown to improve engine performance and efficiency. Most turbochargers include an exhaust gas driven turbine wheel which is coupled to a compressor wheel. The compressor wheel delivers compressed or high pressure air to the air intake of the engine. The turbocharger disclosed in the '061 Patent includes a bore drilled in the aluminum support webs of the compressor cover. The blow-by gas is vented from the crankcase to the bore at the entrance to the compressor of the turbocharger. The blow-by gas is then drawn into the turbocharger and input into the combustion chambers in the engine.

In some turbocharged engines, wherein blow-by gas is re-circulated into the air intake duct upstream of the turbocharger inlet, a deterioration of the turbocharger performance may result from fouling of the turbocharger by the oil and soot particulate matter in the blow-by gas. FIG. 1 depicts an example of turbo compressor efficiency loss over time as a result of fouling. This fouling occurs as the blow-by gas passes through the compressor housing section of the turbocharger. More specifically, in the diffuser section of the turbo compressor where air velocities are the highest, particulate matter deposits may significantly contribute to friction losses resulting in reduced turbo efficiency. It is known to employ filtration or separation systems to reduce the concentrations of the particulate matter in, for example, diesel engines employing CCV. Nonetheless, even filtered concentrations of particulate matter can lead to compressor fouling, especially when the discharge air temperature from the compressor housing is about the same as or greater than the “cracking” temperature of the oil included in the blow-by gas.

### SUMMARY OF THE INVENTION

The present invention provide a turbocharger including a compressor having an air intake, a chamber, and a compressor wheel disposed between the air intake and the chamber and configured to force gas from the air intake into the chamber. The turbocharger further includes a port having an inlet in fluid communication with a source of gas, such as blow-by gas, and an outlet configured to deliver the gas directly into the chamber, thereby re-circulating the gas while reducing fouling of the diffuser section of the turbo compressor. In one embodiment of the invention, the port includes an outlet that is in fluid communication with an annular gap of the compressor chamber, at a location adjacent an outer diameter of the compressor wheel.

The features and advantages of the present invention described above, as well as additional features and advantages, will be readily apparent to those skilled in the art upon reference to the following description and the accompanying drawings.

### BRIEF DESCRIPTION OF THE DRAWINGS

FIG. 1 is a graph of turbo efficiency loss over time.

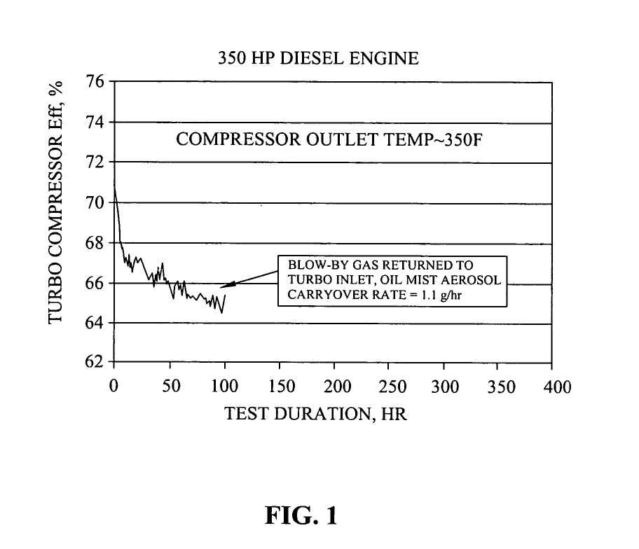

FIG. 2 is a cross-sectional view of a turbocharger according to one embodiment of the present invention.

FIG. 3 is a perspective view, partly in section, of a portion of the turbocharger of FIG. 2.

FIG. 4 is a cross-sectional view taken substantially along lines 4-4 of FIG. 2.

### BRIEF DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

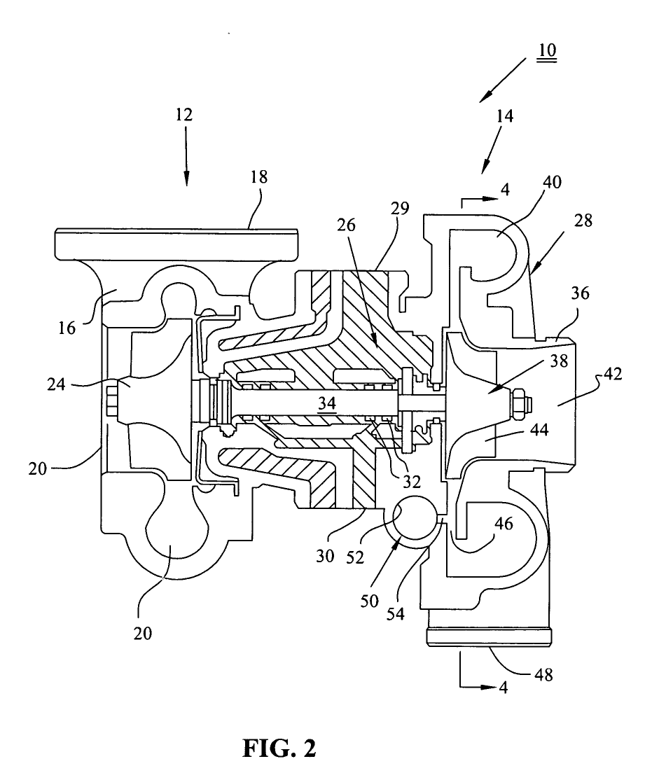

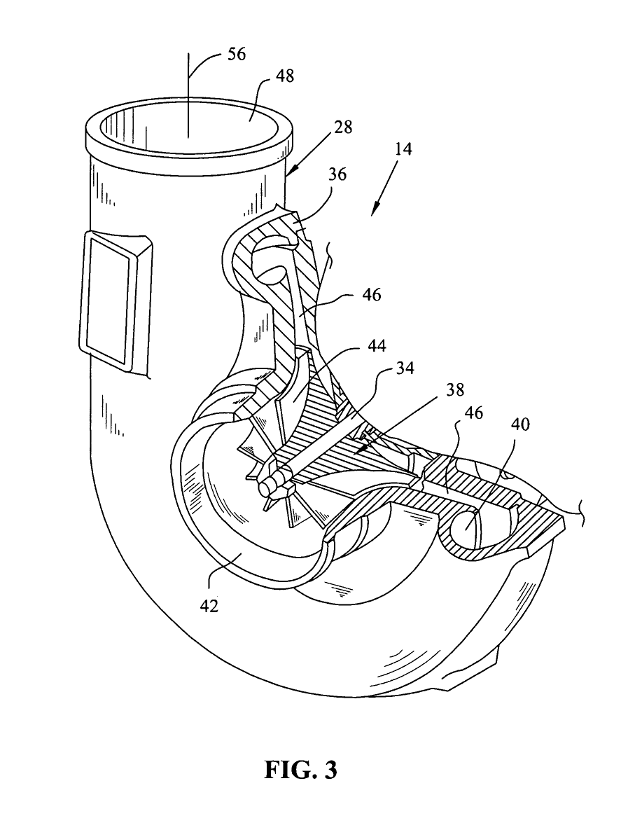

As shown in FIGS. 2 and 3, a turbocharger 10 according to one embodiment of the present invention generally includes a turbine 12 and an air pump 14. Turbine 12 includes a housing 16 that defines an exhaust inlet 18, an exhaust outlet 20, and a turbine chamber 22 therebetween. A turbine wheel 24 is disposed within turbine chamber 16 and is rotationally driven by the flow of exhaust from the vehicle exhaust system through turbine 12 in a manner that is well-known in the art.

Air pump 14 generally includes a bearing assembly 26 and a compressor assembly 28. Bearing assembly 26 includes an oil inlet 29, an oil outlet 30, and structure configured to mount bearings 32, which in turn support a shaft 34. Various different methods of lubricating shaft 34 and mounting shaft 34 within bearing assembly 26 are known in the art. Examples are disclosed in U.S. Pat. No. 4,460,284 and U.S. Pat. No. 5,308,169, the disclosures of which are hereby expressly incorporated herein by reference.

Compressor assembly 28 generally includes a compressor housing 36, and a compressor wheel 38. Compressor housing 36 defines a compressor chamber 40, as will be described in greater detail below, and an air intake 42. Compressor wheel 38 is mounted within compressor housing 36 between air intake 42 and compressor chamber 40. Compressor wheel 38 is connected to shaft 34 and thereby rotates with rotation of turbine wheel 24 as is well-known in the art. Compressor wheel 38 includes a plurality of vanes 44, which are shaped to draw air from air intake 42 and direct that air at high speeds into compressor chamber 40.

As shown in FIG. 3, compressor chamber 40 is shaped generally as a volute, and includes an annular diffuser gap 46 that receives air from vanes 44 of compressor wheel 38. Compressor chamber 40 further includes an outlet 48 which is plumbed to the combustion chambers (not shown) of the engine. As is understood by those of ordinary skill in the art, the cross-sectional area of compressor chamber 40 increases with distance toward outlet 48. Additionally, as a result of operation of compressor wheel 38, the pressure of the gas within chamber 40 generally increases from a minimum pressure at the innermost diameter of gap 46 (i.e., at the outer diameter of compressor wheel 38) to a maximum pressure adjacent the outermost diameter of chamber 40.

Referring back to FIG. 2, air pump 14 also includes a blow-by port 50 which receives blow-by gases from the crankcase (not shown) of the engine. The blow-by gas may be directly routed from the crankcase to blow-by port 50, or may be treated or filtered between the crankcase and blow-by port 50. Also, the pressure of the blow-by gas may be increased before being directed to blow-by port 50 using an additional compressor or pump. As will be further described below, such an increased pressure of the blow-by gas may affect the location of entry of the blow-by gas into the compressor chamber 40. It should be understood, however, that the addition of another pump or compressor may also increase the cost and complexity of the system. In one embodiment of the invention, blow-by port 50 includes an inlet 52 that is defined in bearing assembly 26, although it should be understood that inlet 52 may be located elsewhere on turbocharger 10 such as, for example, on compressor housing 36. In any case, blow-by port 50 further includes an outlet 54 which is in fluid communication with chamber 40. Inlet 52 and outlet 54 are connected by an appropriately formed chamber (not shown).

In an alternative embodiment, port 50 is configured as a separate insertable or attachable component that may be installed in or on compressor housing 36. Such a port 50 configuration may provide added design and manufacturing flexibility. For example, the number and size of inlets 52 and outlets 54 may be modified without modifying air pump 14, as can the location of introduction of the blow-by gas and the direction or angle of introduction.

The specific location of outlet 54 may vary depending upon the geometry of compressor chamber 40. In general, however, outlet 54 is positioned such that it directs the blow-by gas into annular diffuser gap 46 such that the exposure of the internal surface area of chamber 40 to the carbonaceous contaminants in the blow-by gas is minimized. It should also be understood, however, that outlet 54 should be located such that the static pressure at outlet 54 does not result in excessive crankcase static pressure. Accordingly, it is desirable to locate outlet 54 near compressor outlet 48 and at a location where the pressure within chamber 40 is negative relative to the pressure of the blow-by gas, such as within diffuser gap 46. Of course, if a pump or compressor is used to increase the pressure of the blow-by gas before introduction into chamber 40, then outlet 54 may be located within gap 46 farther from the outer diameter of compressor wheel 38 than would otherwise be possible.

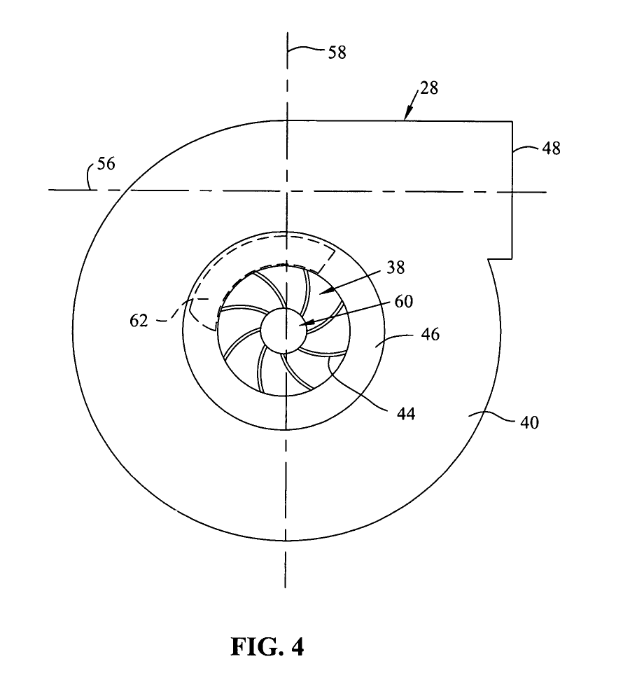

Referring now to FIG. 4, a region of possible locations for introduction of the blow-by gas through outlet 54 into chamber 40 are shown in dotted lines. As shown, compressor outlet 48 in this embodiment is at the upper right-hand-side of the figure. A longitudinal axis 56 may be drawn through compressor outlet 48 horizontally across the figure. A vertical axis 58 may be drawn such that it is perpendicular to axis 56 and passes through a central portion 60 of compressor wheel 38. The intersection of these axes 56, 58 may define a 12:00 position (a 0:00 position on European/military clocks) wherein compressor chamber 40 is viewed as the face of a clock and compressor wheel 38 rotates in a clockwise direction. In this particular geometric configuration, it can be seen that the volume of the gas within compressor chamber 40 increases from a minimum value at approximately 3:00 (6:00 European/military) to a maximum value at approximately 1:30 (3:00 European/military). Given the pressure characteristics of gases within typical compressor chambers 40 and the pressure characteristics of blow-by gas delivered directly from the crankcase, it may be generally stated that outlet 54 of blow-by port 50 may be appropriately located within a region 62 of locations falling approximately between the 9:00 and the 1:30 positions (18:00 and 3:00 positions, European/military). Region 62 of locations of outlet 54 results in an acceptable exposure of surface area of chamber 40 to the blow-by gases which reduces the fouling of the turbocharger and the associated performance loss.

As is also shown in FIG. 4, region 62 includes a radial dimension relative to central portion 60 of compressor wheel 38. As indicated above, the pressure of the gas within compressor chamber 40 increases with radial distance from central portion 60. Within the radial dimension of region 62, the static pressure of the gas within compressor chamber 40 remains less than the maximum allowable “draw” from the closed crankcase ventilation (“CCV”) system. In one embodiment of the invention, blow-by outlet 54 is positioned such that blow-by gas is introduced into compressor chamber 40 at the innermost radius within region 62. As should be apparent from the foregoing, the selection of a radial location of blow-by outlet 54 may be influenced by the selected angular location, and vice-versa. It should also be understood that outlet 54 may be sized to accommodate various gas flows and may be implemented as multiple outlets formed in an arc or spiral pattern within region 62.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A turbocharger, including:
a compressor having a housing that defines an air intake and a chamber, and a compressor wheel disposed between the air intake and the chamber, the compressor wheel being configured to force gas from the air intake into the chamber;
a port having an inlet in fluid communication with a source of gas and an outlet configured to deliver the gas directly into the chamber.

2. The turbocharger of claim 1, wherein the chamber includes an annular gap, the outlet being formed in the compressor housing in fluid communication with the gap.

3. The turbocharger of claim 1, wherein the gas is crankcase blow-by gas.

4. The turbocharger of claim 1, wherein the chamber defines a substantially circular path of travel of the gas within the chamber around the compressor wheel and the port outlet is located within a region of locations that occupies an arcuate portion of the path of travel.

5. The turbocharger of claim 4, wherein the region of locations is bounded by a first limit and a second limit that is radially farther than the first limit from a central portion of the compressor wheel.

6. The turbocharger of claim 5, wherein a pressure of the gas in the chamber at the second limit is less than a maximum allowable draw from a CCV system associated with the turbocharger.

7. The turbocharger of claim 1, wherein the chamber is substantially circular and has a outlet at one end, the chamber further including a 12:00 location at an intersection of a longitudinal axis through the outlet and a perpendicular axis that passes through a central portion of the compressor wheel.

8. The turbocharger of claim 7, wherein the port outlet is formed in the compressor housing within an angular region of locations extending from a 9:00 location to a 1:30 location relative to the 12:00 location.

9. The turbocharger of claim 8, wherein the port outlet is disposed radially relative to the central portion of the compressor wheel in a region corresponding to a static pressure within the chamber that is less than a maximum allowable draw of a CCV system coupled to the turbocharger.

10. The turbocharger of claim 9, wherein the port outlet is disposed at an innermost radial location within the region.

11. The turbocharger of claim 1, wherein the gas is filtered before being directed into the chamber.

12. The turbocharger of claim 1, wherein the gas is provided by a pump having an inlet for receiving crankcase blow-by gas at a first pressure and an outlet for providing the blow-by gas at a second pressure that is higher than the first pressure.

13. The turbocharger of claim 1, wherein the port outlet delivers the gas into the chamber at a location that substantially minimizes an amount of surface area within the chamber that is exposed to the gas.

14. The turbocharger of claim 1, wherein the port outlet includes a plurality of outlets.

15. The turbocharger of claim 1, wherein the port outlet is formed on an insert that is removably coupled to the compressor.

16. A method for decreasing the efficiency loss of a turbocharger compressor having a wheel and configured to re-circulate crankcase blow-by gas, the method including the step of:
introducing the blow-by gas into a chamber defined by the compressor at a location downstream of the compressor wheel.

17. The method of claim 16, further including the step of selecting the location such that a pressure of a gas forced into the chamber by the compressor wheel is less at the location than a pressure of the blow-by gas at the location.

18. The method of claim 16, further including the step of coupling an insert to the compressor, the insert including an outlet for introducing the blow-by gas into the chamber.

19. The method of claim 16, further including the step of selecting the location to minimize a distance of travel of the blow-by gas within the chamber, while avoiding creation of excessive static pressure in the crankcase.

20. The method of claim 16, further including the step of selecting the location such that a pressure of a gas forced into the chamber by the compressor wheel is less at the location than a maximum allowable draw from a CCV system associated with the turbocharger.

21. The method of claim 16, further including the step of filtering the blow-by gas before performing the introducing step.

22. The method of claim 16, further including the step of pressurizing the blow-by gas before performing the introducing step.

23. A turbocharger compressor, including:
a housing defining an air intake and a chamber; and
a wheel mounted to the housing for transporting air from the air intake to the chamber;
wherein the housing further includes a port configured to deliver crankcase blow-by gas into the chamber.

24. The turbocharger compressor of claim 23, wherein the chamber includes an annular gap, the port being formed in the compressor housing in fluid communication with the gap.

25. The turbocharger compressor of claim 23, wherein the port is formed in a wall of the chamber at a location wherein the pressure of the air in the chamber is less that a pressure of the blow-by gas.

26. The turbocharger compressor of claim 23, wherein the port is disposed radially relative to a central portion of the wheel in a region corresponding to a static pressure of the air within the chamber that is less than a maximum allowable draw of a CCV system coupled to the turbocharger compressor.

27. The turbocharger compressor of claim 23, wherein the port is positioned to deliver the blow-by gas into the chamber at a location that substantially minimizes an amount of surface area within the chamber that is exposed to the blow-by gas.

28. A turbocharger, including:
means for driving a shaft;
means for pressurizing air for delivery to a combustion chamber, including means, driven by the shaft, for forcing air into a compressor chamber;
means for introducing blow-by gas into the compressor chamber downstream of the forcing means.
